(19) United States
(12) Patent Application Publication
(10) Pub. No.: US 2011/0038721 A1
(43) Pub. Date: Feb. 17, 2011

(54) FAN WITH DUST-RESISTANT COATING

(75) Inventor: Stefan DENNER, SINGEN (DE)

Correspondence Address: Oliver Intellectual Property LLC, P.O. Box 1670, Cotuit, MA, 02635, US

(73) Assignee: EBM-PAPST ST. GEORGEN GMBH & CO. KG, ST. GEORGEN (DE)

(21) Appl. No.: 12/856,784

(22) Filed: Aug. 16, 2010

(30) Foreign Application Priority Data
Aug. 17, 2009 (DE) 10 2009 037 769.7

(51) Int. Cl. F04D 29/42; B29C 45/16; F03B 3/12

(52) U.S. Cl. 415/182.1; 264/39; 416/241 R; 977/902

(57) ABSTRACT

A method of making a fan having one or more dust-resistant surfaces comprises the steps of: providing (S50) an open mold for injection-molding purposes, having a cavity (43) corresponding to the desired configuration of fan components to be formed; wetting (S52) the surface of the cavity (43) with a mixture (24) of nanoparticles (19) and a solvent carrier; evaporating (S54) said solvent carrier, thereby depositing said nanoparticles on the wall of the cavity (43); closing (S56) the injection mold (10, 12); injecting (S58) thermoplastic (42) into the cavity (43); permitting the thermoplastic to harden, thereby binding the nanoparticles into the surface of the thus-created component(s), and removing (S60) the completed component(s) from the mold, for subsequent assembly as part of a fan.

### CROSS-REFERENCE

This application claims priority from my German application DE 10 2009 037 769.7 filed 17 Aug. 2009, the entire content of which is hereby incorporated by reference.

### FIELD OF THE INVENTION

The present invention relates generally to a fan with a molded plastic component and, more particularly, to a method of making such a fan with improved dust-resistance characteristics.

### BACKGROUND

Fans are often used in environments in which dust is present. This dust tends to adhere to the fan blades and other components, which necessitates frequent cleaning of the soiled components.

### SUMMARY OF THE INVENTION

It is therefore an object of the invention to provide an improved fan with dust-resistance characteristics. Preferably, this is accomplished by adding a preliminary step, of applying a solution incorporating nanoparticles, into the process of injection-molding plastic components of the fan. Through the binding of nanoparticles to the outer surface of the injection-molded fan wheel and similar components, one obtains a fan whose surface resists adherence of dust, thereby lengthening the time interval between necessary cleaning operations.

A fan whose outer surface contains nanoparticles can be simply cleaned by just spraying with water, since water beads up on such a treated surface and takes with it any dust which may have adhered to the fan wheel, for example. Thus, a simple cleaning procedure using an environmentally friendly medium is enabled. A further advantage is that painting or lacquering of the relevant components is no longer necessary.

### BRIEF FIGURE DESCRIPTION

Further details and advantageous refinements of the invention will be apparent from the following description and drawings of an exemplary embodiment, which is illustrative, but is not to be understood as limiting the scope of the invention.

FIG. 1 schematically illustrates the wetting of an injection mold or form 10, 12 with a solution containing nanoparticles 19;

FIG. 2 is an enlarged schematic, analogous to FIG. 1, showing the wetting of a form 10 with a nanosolution 24;

FIG. 3 schematically illustrates the injection of a suitable thermoplastic into a closed form or mold 10, 12;

FIG. 4 shows a molded component 42 with a layer of nanoparticles, the layer of particles being greatly exaggerated in size, for purposes of easier comprehension;

FIG. 5 is a flowchart schematically illustrating a preferred sequence of manufacturing steps in accordance with the invention;

FIG. 6 is a perspective view of a fan housing of plastic; and

FIG. 7 is a perspective view of a fan wheel having a surface layer of nanoparticles.

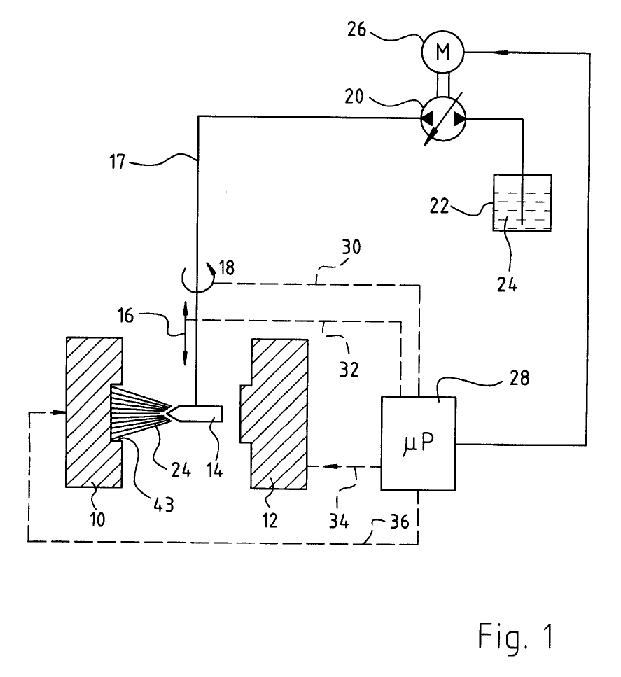

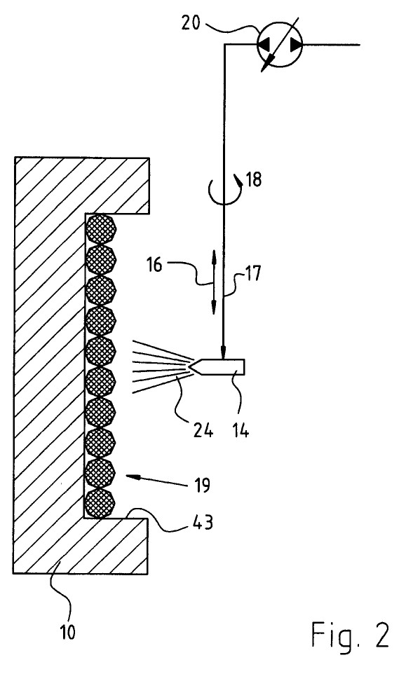

### DETAILED DESCRIPTION

Between parts 10 and 12 of a mold, there is provided a nozzle head 14 which, as shown, is movable axially (as shown by arrow 16) and rotationally (as shown by arrow 18). Using a pump 20 and a supply line 17, the nozzle head 14 is coupled to a storage reservoir 22 containing a nanosolution 24. Suitable nanosolutions, for example nanoparticles in a propanol carrier, are known in the trade and therefore need not be described in detail here. For driving pump 20, a motor 26 is provided, controlled by a microprocessor 28. The latter also controls, via respective control signal lines 30 and 32, the rotation and axial movement of nozzle head 14. Microprocessor 28 also controls, via couplings 34, 36, the opening/closing movements of injection mold forms 10, 12.

### Mode of Operation

Prior to making a fan component, the empty injection mold 10, 12 is opened, and the nozzle head 14 is moved, by an axial movement 16, into position between mold portions 10, 12. Motor 26 is actuated, so that pump 20 supplies nozzle head 14 with nanosolution 24, and the head wets the inner surface of portion 10 with nanosolution 24, the nozzle head carrying out suitable rotational movements 18 to wet all the desired places in the mold. Once the mold has been wetted in all the desired places, one moves nozzle head 14 up and out of the way, and permits the mold to dry out.

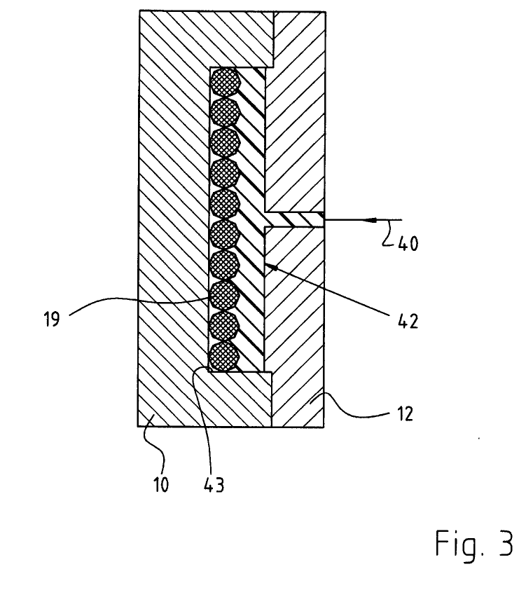

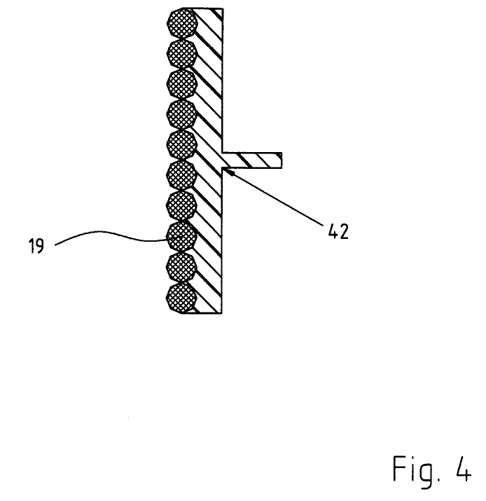

Then, as shown in FIG. 3, the mold portions 10, 12 are brought together to define a closed space or cavity 43, and via a supply line 40, thermoplastic 42 is injected into cavity 43, to thereby form a molded fan component. The nanoparticles 19, which were left behind by the evaporation of the solvent carrier as the mold dried out, thus bind with the surface of the injected plastic 42, thereby forming a dust-resisting or dust-repelling surface.

Subsequently, mold portions 10, 12 are moved apart from each other, and the thus-molded and hardened fan component 42 is removed from cavity 43. It can then be assembled with a fan stator/rotor, bearings, and electric components, in the usual manner, to form a completed fan.

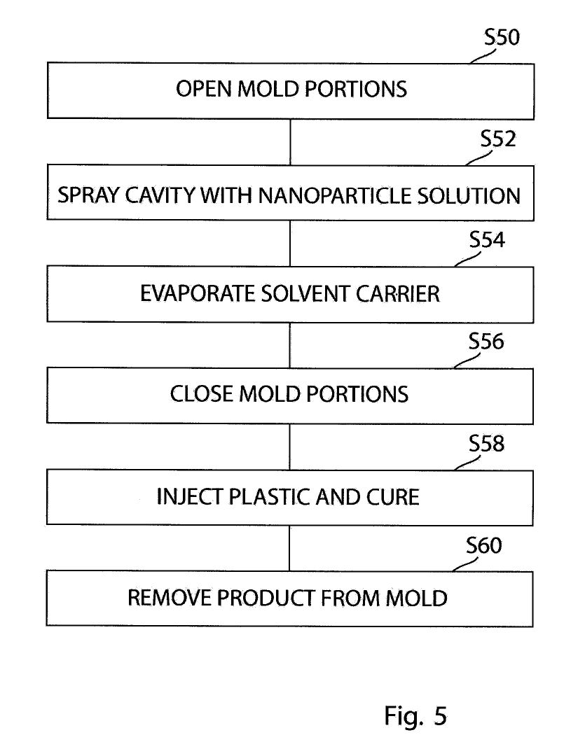

FIG. 5 illustrates the preferred sequence of steps: in a first step S50, the mold portions 10, 12 are opened; in step S52, the cavity 53 is sprayed or wetted with nanosolution; in step S54, one allows the solvent carrier, e.g. propanol, to evaporate; in step S56, mold portions 10, 12 are closed; in step S58, plastic 42 is injected into closed cavity 43 and permitted to harden or cure; and in step S60, mold portions 10, 12 are opened and the thus-molded component 42 with its nanoparticle layer 19 is removed from cavity 43.

Successful trials of the inventive process were performed using the nanosolution “VP Disp. LE 5315X” which is commercially available from the firm Evonik Degussa GmbH of Hanau, Germany. This nanosolution contains silanamine, 1-1-1-Trimethyl-(Trimethylsilyl-hydrolysis products with silicon dioxide (US EPA code 100162) and 2-Propanol. The flashpoint of 2-Propanol is approximately 82° C or 181° F. The nanosolution was sprayed into the cavity prior to injection of the plastic and type of plastic used to mold the rotor was polyamide. It is also possible to instead use PA 66 (polyamide 66) or PA 66 GF 30, a polyamide supplemented with 30% glass fiber content. The nanoparticles were, after the injection process, found to have successfully embedded in the surface of the fan wheel material. Water applied to the product beaded up, as expected, and transported away dust previously deposited on the fan blades. The contact angle of water on the surface of fan blades, using polyamide without nanoparticles was about 60 degrees, while when using polyamide with nanoparticles, the contact angle increased to about 160 degrees.

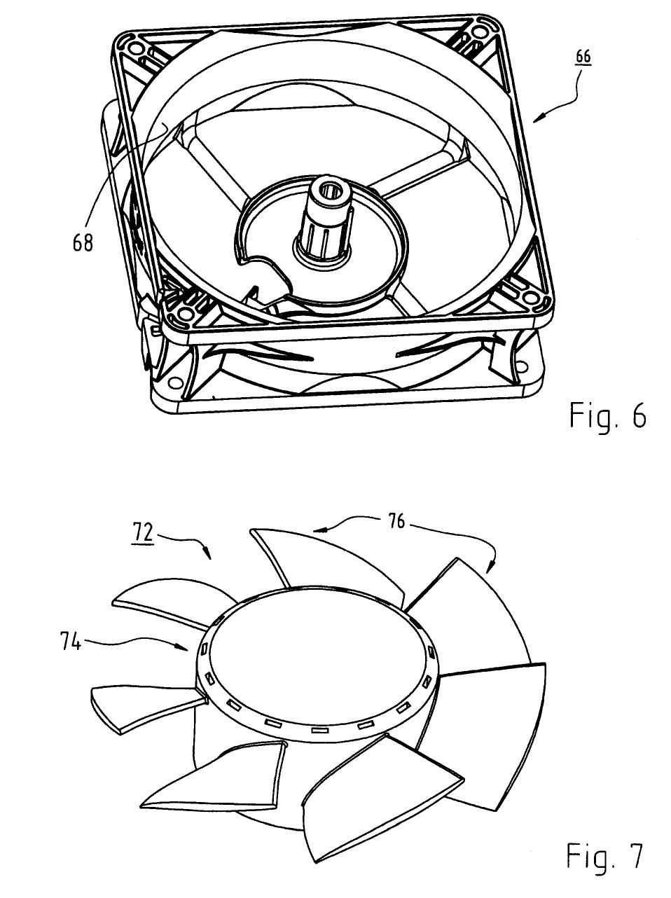

FIG. 6 shows a fan component, this time in the form of a fan housing 66 of plastic material. It has a recess 68 having the form of a Venturi channel for passage of air when the fan is operating. Prior to the improvement made by the present invention, such channels often tended to become collection points for dust.

Therefore, in accordance with the present invention, the surface of the Venturi channel 58 is provided with a layer of nanoparticles. When such a nanoparticle layer is used, one finds that substantially less dust and dirt are deposited and, to the extent that any dust still is found, any necessary cleaning is made significantly easier.

FIG. 7 shows a fan component in the form of a fan wheel 72. This has a hub 74 of plastic, on whose periphery seven vanes or blades 76, also of plastic, are formed.

In this case, the outer face of the hub 74 is provided with a nanoparticle layer (which is not feasible to illustrate) and likewise, both sides of each vane or blade 76 is provided with a nanoparticle layer, in order to minimize the deposit of dust and dirt on the vanes or blades.

In many cases, for cleaning, it suffices to spray a bit of water into the rotating fan, since this causes the dust to release from the relevant surfaces, so that it can be easily removed.

It will be apparent, to those of ordinary skill in the art, that numerous variations and modifications of the foregoing exemplary embodiment are possible, within the scope of the inventive concept.

For example, one could use alternative solvent carriers, such as n-butanol or iso-butanol. Suitable nanoparticle materials include silica, minerals, metal oxides, silicic acid salts and/or titanium dioxide.

What is claimed is:

1. A fan having at least one component of thermoplastic made by the steps of:
providing an injection mold (10, 12) defining a cavity (43) corresponding to the shape of the component to be made;
wetting the surface of said cavity with a solution of nanoparticles (19) and a carrier fluid;
permitting said carrier fluid to evaporate, leaving behind a layer of said nanoparticles (19);
closing said injection mold (10, 12) and injecting thermoplastic (42) into the closed cavity (43), thereby forming a molded component with said nanoparticles (19) bound into surfaces thereof; and
removing the thus-molded component (66, 72) from the mold.

2. The fan of claim 1, wherein said component is a fan wheel (72) of the fan.

3. The fan of claim 2, wherein said nanoparticles are bound to the blades (76) of said fan wheel (72).

4. The fan of claim 2, wherein the said nanoparticles are bound to a hub (74) of said fan wheel (72).

5. The fan of claim 1, wherein said component is a housing (66) of said fan.

6. The fan of claim 6, wherein said housing (66) comprises a wall portion (68) defining an air guidance channel, and said nanoparticles (19) are bound to said wall portion (68).

7. The fan of claim 1, wherein a solvent carrier for said nanoparticles consists essentially of propanol.

8. The fan of claim 1, wherein a solvent carrier for said nanoparticles consists essentially of butanol.

9. A method of making an injection-molded component, comprising the steps of
providing an injection mold (10, 12) defining a cavity (43) corresponding to the shape of the component to be made;
wetting the surface of said cavity with a solution of nanoparticles (19) and a carrier fluid;
permitting said carrier fluid to evaporate, leaving behind a layer of said nanoparticles (19);
closing said injection mold (10, 12) and injecting thermoplastic (42) into the closed cavity (43), thereby forming a molded component with said nanoparticles (19) bound into surfaces thereof; and
removing the thus-molded component (66, 72) from the mold.

10. The method of claim 9, further comprising further comprising
maintaining said mold at a temperature exceeding a boiling point of said carrier fluid.

11. The fan of claim 1, wherein said molded component is a housing of the fan.
